(19) United States
(12) Patent Application Publication
(10) Pub. No.: US 2025/0354962 A1
(43) Pub. Date: Nov. 20, 2025

(54) CALIBRATION BLOCK AND METHOD OF MANUFACTURING

(71) Applicant: General Electric Company, Schenectady, NY (US)

(72) Inventors: Richard DiDomizio, Charlton, NY (US); Christopher Thomas McLasky, Glenville, NY (US); Edward James Nieters, Burnt Hills, NY (US)

(21) Appl. No.: 18/665,292

(22) Filed: May 15, 2024

(51) Int. Cl. G01N 29/30

(52) U.S. Cl. CPC G01N 29/30

(57) ABSTRACT

Provided herein is a calibration block comprising a controlled crack disposed within the volume of a hard to crack material, where the controlled crack has a predetermined location and a predetermined maximum length. Also provided are methods of making a calibration block having a controlled crack. In some aspects, the calibration block comprises a first material and a second material positioned in a volume of the first material. An interface of the first material and the second material has a signal amplitude that is less than about 50% a signal amplitude produced by the controlled crack as detected by an inspection device. The second material includes at least one crack having a predetermined location defined by the position of the second material within the block and predetermined length defined by a size of the second material.

### TECHNICAL FIELD

These teachings relate generally to a calibration block for use in calibration of non-destructive inspection methods and methods for making such a calibration block.

### BACKGROUND

Parts for engines, such as jet engines and gas turbine engines, may be inspected using non-destructive evaluation (NDE) methods. NDE methods may be used to check for defects or anomalies in parts in order to gather useful information about the fitness for service or remaining life of the part. In some approaches, calibration blocks may be used to calibrate NDE equipment. Calibration blocks provide specific targets that are used to provide an estimate of real-world defects or anomalies found in parts being inspected. As such, calibration blocks that improve the accuracy of calibration and more closely calibrate an NDE device to real-world defects or anomalies may be beneficial.

### BRIEF DESCRIPTION OF DRAWINGS

Various needs are at least partially met through provision of the calibration block and method of manufacturing described in the following detailed description, particularly when studied in conjunction with the drawings. A full and enabling disclosure of the aspects of the present description, including the best mode thereof, directed to one of ordinary skill in the art, is set forth in the specification, which refers to the appended figures, in which:

FIG. 1 is a schematic diagram of a calibration block, in accordance with some embodiments;

FIG. 2 is a flow diagram of a calibration method, in accordance with some embodiments;

FIG. 3A is a schematic diagram illustrating placement of a second material within a first material, in accordance with the method of FIG. 2;

FIG. 3B is a schematic diagram illustrating placement a second material within a first material, in accordance with the method of FIG. 2;

FIG. 3C is a schematic diagram of an interface between the first material and the second material, in accordance with the method of FIG. 2;

FIG. 3D is a schematic diagram illustrating deformation of an uncracked solid body to form at least one crack, in accordance with the method of FIG. 2;

FIG. 3E is a schematic diagram illustrating the machining of a calibration block to a target shape, in accordance with the method of FIG. 2;

FIG. 4 is an ultrasound C-scan image of an uncracked solid body manufactured via the methods described herein;

FIG. 5 is an ultrasound C-scan image of a cracked calibration block manufactured via the methods described herein;

FIG. 6 is a graph of ultrasonic (UT) inspection data acquired from the uncracked solid body of FIG. 4;

FIG. 7 is a graph of UT inspection data acquired from the uncracked solid body of FIG. 4;

FIG. 8 is a graph of UT inspection data acquired from the cracked calibration block of FIG. 5; and

FIG. 9 is a graph of UT inspection data acquired from the cracked calibration block of FIG. 5.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required.

### DETAILED DESCRIPTION

Non-destructive evaluation (NDE) inspection methods are commonly used to inspect parts, such as parts in a gas turbine engine (e.g., a rotor blade, a stator vane, etc.), for certain defects. NDE inspection methods are performed with equipment or devices such as ultrasonic inspection devices, eddy current inspection devices, fluorescent penetrant inspection devices, or other surface inspection devices. One common type of defect encountered with NDE inspections is a crack in a part. Cracks may be present either at the surface of a part or, in some instances, may be disposed below the surface within an internal volume of the part. Traditional calibration blocks typically include one or more surface exposed holes or notches of a known size as the calibration targets. For example, the calibration targets may be a series of flat-bottomed machined holes or notches in the calibration blocks. It is common practice to calibrate NDE equipment using calibration blocks constructed with such holes or notches to approximate cracks or inclusions. For example, the size of the hole or notch may be used as an estimate for the size of a defect, such as a crack, detected by the NDE equipment. When the defect is a crack, however, the holes or notches may not closely approximate the real-world defect and, accordingly, may lead to incorrect estimates of defect shapes and sizes.

To better approximate real-world defects such as cracks, the calibration blocks described herein have at least one crack formed therein as the calibration target. The crack may be a controlled crack that is intentionally formed in the calibration block. The controlled cracks have a predetermined or known location and size and/or geometry within the calibration block to enable the NDE signal to be directly compared with the known crack size and/or geometry. The cracks in the calibration block mimic the geometry of defects encountered within the volume of material being inspected (e.g., a target part) and, accordingly, provide a more accurate point of comparison for the purpose of calibrating inspection equipment.

Methods of manufacturing a calibration block also are provided herein. The methods allow for controlled cracks to be produced completely within the internal volume of a calibration block (e.g., subsurface cracks). Further, the methods described herein allow for controlled cracks to be formed in materials that are hard to crack when subjected to small strains, such as those alloys used for structural applications at room or elevated temperatures.

Certain parts and accordingly, calibration blocks that are representative of such parts, are made of materials that are hard to crack when subjected to small strains. While it is understood that large enough strains produce cracks in hard to crack materials, those large strains will also change the grain structure (e.g., microstructure) of the hard to crack material with either built up retained strain or with a change in grain size following recrystallization at elevated temperature. Both these changes in microstructure of the hard to crack material will change the NDE signal and make a calibration block made of a hard to crack material less comparable to the real-world part that is to be inspected. Accordingly, it may be difficult to introduce a controlled crack into the calibration block material, in particular, without impacting the microstructure of calibration block material. Thus, a goal for the calibration blocks described herein is to produce fully embedded cracks in hard to crack materials with a minimum of applied strain to preserve the representative microstructure of the hard to crack material. The NDE signal characteristics of hard to crack materials in the calibration blocks described herein may remain unchanged or minimally changed with the introduction of the crack therein to ensure the calibration block remains comparable to the real-world part to be inspected.

The methods described herein enable a controlled crack to be produced in a hard to crack material, e.g., first material, by embedding or placing a second material within the first material such that a metallurgical bond is achieved between the first material and the second material. By some approaches, the second material has a lower ductility and/or a lower fracture toughness than the first material. As such, it may be easier to introduce a crack into the second material than into the first. Further, by some approaches, the second material has an acoustic impedance that is the same or similar to the acoustic impedance of the first material. In this manner, the uncracked second material may be invisible or nearly invisible to an inspection device. In the calibration blocks described herein, any signal that results from material differences (e.g., a signal from an interface between the first material and the second material) during an inspection is minimized or reduced. In some examples, a signal for an interface between the first material and the second material is invisible or nearly invisible to an inspection device. An interface between the first material and the second material that is invisible or nearly invisible to an inspection device may have a signal amplitude that is about 50% or less than a signal amplitude of the crack in the second material as detected by the inspection device. An interface that has or results in a signal amplitude that is in the aforementioned range results in the crack in the calibration block, and not the interface between the first material and the second material, producing the dominant signal and when using the calibration block. Thus, the inspection device is able to detect the crack for calibration purposes rather than features of the calibration that are not of interest for calibration, such as the interface between the first material and the second material and the signal from the interface does not interfere with the signal from the crack. In the approaches described herein, the second material is embedded in the first material to form an uncracked solid body. The uncracked solid body is then subjected to deformation. Deformation causes a crack to form in the second material, without cracking the first material or the interface of the first material and the second material.

Further, there are challenges associated with creating a crack that has an intentionally chosen size and location within a calibration block. The methods described herein leverage the second material, which is easier to crack than the first material, to set the size and location of the cracks formed in the calibration block. The second material may be intentionally positioned at a target location within the first material to set a location of the crack within the calibration block. Similarly, the dimensions and/or shape of the second material may set the size of the crack.

As used herein, “controlled crack” refers to a crack that is intentionally formed and has a known or predetermined size, geometry, and/or location.

As used herein, “hard to crack material” refers to a material in which it is difficult to induce a crack to form with small, applied strains. In some examples, a hard to crack material is a material having a high ductility and a high fracture toughness.

As used herein, “room temperature” refers to a temperature within the range of about 68 degrees Fahrenheit to about 72 degrees Fahrenheit.

As used herein, “structural alloy” refers to an alloy that has a balance of properties that include a ductility and fracture toughness sufficient to withstand stresses applied to a component over a lifetime of the component. Structural alloys include, but are not limited to, aluminum-based alloys, titanium-based alloys, refractory-based alloys, nickel-based superalloys, or steels. In some examples, a structural alloy may include at least one of an aluminum-based alloy, a titanium-based alloy, a refractory-based alloy, a nickel-based superalloy, or a steel.

In some aspects, a calibration block as described herein comprises a first material and a second material embedded within a volume of the first material. The first material may be a hard to crack material, as defined by high ductility and a high fracture toughness. The calibration block includes a controlled crack disposed fully within the second material. The controlled crack is intentionally formed in the calibration block and has a predetermined location and a predetermined maximum length. In the calibration block, an interface of the first material and the second material produces a signal amplitude that is less than about 50% a signal amplitude produced by the controlled crack in the second material as detected by an inspection device.

In some aspects, a calibration block as described herein has an outer surface defining an inner volume. The inner volume comprises a first material and a second material. The second material fills or occupies at least a portion of the inner volume. The second material is disposed or embedded in the first material. The second material may be spaced from the outer surface of the calibration block. The second material includes at least one crack having a predetermined location and a predetermined maximum length. In the calibration block, an interface of the first material and the second material produces a signal amplitude that is less than about 50% a signal amplitude produced by the at least one crack as detected by an inspection device.

In some aspects, a method of manufacturing a cracked calibration block in accordance with the approaches described herein includes embedding or placing a second material within a first material. For example, the method may include filling a container to a target position with a powder of a first material, placing a consolidated piece of a second material in the container at the target position, and filling a remainder of the container with the powder of the first material. The second material is less ductile than the first material. Further, the second material having at least one dimension that defines a target crack size. The method further includes subjecting the container to heat and pressure to form an uncracked solid body. The heat and pressure are sufficient to cause diffusion between the first material and the second material creating a metallurgical bond. The method also includes deforming the uncracked solid body to create at least one crack in the second material and form a cracked calibration block. In some approaches, the method further includes machining the cracked calibration block to the target shape. The target shape has a geometry that mimics a shape of at least a portion of a target part. Examples of the target part include but are not limited to components of an aircraft engine such as aircraft engine rotating components, pipe welds, structural metals that undergo cyclic fatigue, etc.

The calibration blocks described herein may be used to calibrate various types of NDE inspection devices. Examples of NDE inspection devices that may be calibrated using the calibration blocks described herein include but are not limited to ultrasonic inspection, eddy current inspection, fluorescent penetrant inspection, or the other surface inspection devices.

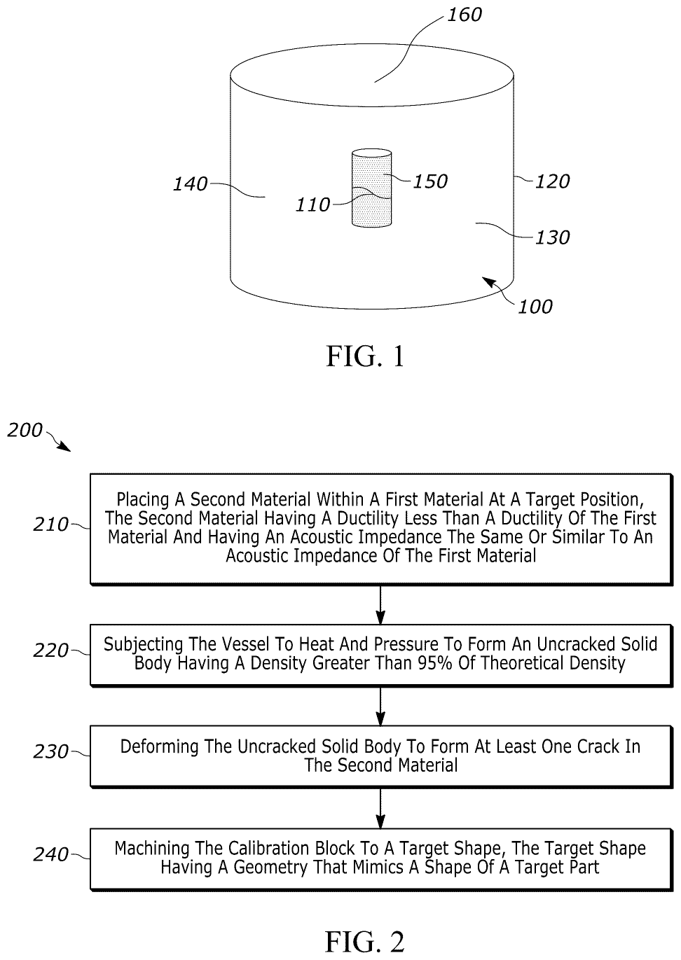

Referring now to the drawings, and in particular to FIG. 1, a calibration block 100 is shown. The calibration block 100 is made of a first material 140 and a second material 150 that is disposed within the first material 140. The calibration block 100 includes a crack 110 disposed fully within the volume of the calibration block 100. The crack 110 may be a controlled crack. The crack 110 may have a predetermined location within the calibration block 100. For example, the predetermined location is intentionally chosen and introduced into the calibration block 100 using the methods described herein. By some approaches, the crack 110 is intentionally introduced into a predetermined location of the calibration block 100 using the method 200 described with reference to FIG. 2. Further, the location of the crack 110 within the calibration block 100 is known. The location of the crack 110 is known in that the location is intentionally fixed or established within the calibration block 100 using the approaches described herein and/or in that the location does not need to be determined via inspection of the calibration block 100. In addition, the crack 110 may have a predetermined maximum length. For example, the predetermined maximum length is known in that the maximum length is intentionally established using the approaches described herein and/or in that the location does not need to be determined via inspection of the calibration block 100. In one example, the predetermined maximum length is intentionally established by the at least one dimension of a piece of the second material 150 that is disposed or embedded within the first material 140.

The calibration block 100 has an outer surface 120 that defines an inner volume 130. In some embodiments, the crack 110 is disposed within the inner volume 130 of the calibration block. For example, the crack 110 may be embedded in an inner volume 130 of the calibration block 100 and spaced from the outer surface 120. By some approaches, the crack 110 is spaced from the outer surface 120 by a predetermined distance that is intentionally established using the approaches herein. In other embodiments, the crack 110 or portions thereof is disposed at the outer surface 120 of the calibration block 100. The crack 110 may be disposed fully within the second material 150.

The calibration block 100 is composed of the first material 140, e.g., a bulk material, and the second material 150, e.g., a seed material. The first material 140 fills at least a portion of the inner volume 130. The first material 140 may be a hard to crack material as defined by a high ductility and a high fracture toughness. The hard to crack material may be a material in which it is difficult to induce a crack to form with small, applied strains. By some approaches, the calibration block 100 (e.g., the final calibration block 100 after the first material 140 has been joined with the second material 150) has not undergone strains as measured at room temperature in excess of about 20%, about 15%, about 12% or, in some aspects, about 10%. Strain (e.g., change in length divided by initial length) is a unitless quantity. For the aforementioned strains, the unitless quantity was multiplied by 100 to represent the strain as a percent. The second material 150 is disposed or positioned within the first material 140. The second material 150 may be spaced from the outer surface 120 of the calibration block 100. The crack 110 is disposed in the second material 150. The second material 150 may be formed as a discrete block or consolidated piece of material disposed within the first material 140 (e.g., fully enveloped or surrounded by the first material 140). The second material 150 may be a discrete block or piece of material of any suitable shape and/or size. By some approaches, the size and/or at least one dimension of the second material 150 sets the maximum length of the crack 110.

In some embodiments, the first material 140 is a metallic material. In some aspects, the first material 140 is a material that is representative of a material of a target part (e.g., a part to be inspected via the inspection equipment calibrated using the calibration block 100). By some approaches, the first material 140 is a material that has a shear modulus that is the same or similar to a shear modulus of the material of the target part. For example, the first material 140 may have a shear modulus that differs by about 20% or less, about 10% or less, about 5% or less, or about 2% or less from the shear modulus of the target part. By some approaches, the first material 140 is a material that has a shear modulus that is the same or similar to a shear modulus of the material of the target part. For example, the first material 140 may have a shear modulus that differs by about 20% or less, about 10% or less, about 5% or less, or about 2% or less than the shear modulus of the target part. By some approaches, the first material is a material that is the same or similar to a material of the target part. The first material 140 may be a structural alloy. In some examples, the first material 140 is a nickel-based superalloy.

In some embodiments, the first material 140 is a structural alloy that is used in a jet engine or a heavy-duty gas turbine where the structural alloy is subjected to elevated temperature service. Structural alloys used in a jet engine or heavy-duty gas turbine include but are not limited to steels, titanium-based alloys, or nickel-based superalloys. In one non-limiting example, the first material 140 has a ductility, as measured by elongation to fail, at room temperature of greater than about 8% and a fracture toughness at room temperature of greater than 25 ksi square root inches (ksi√in). In one example, the first material 140 is Rene88DT.

In some embodiments, the second material 150 is a metallic material. The second material 150 is less ductile (e.g., more brittle) than the first material 140. That is, the second material 150 has a ductility less than a ductility of the first material 140. As such, the second material 150 is easier to crack than the first material 140, for example, when subjected to strain. Further, in some embodiments, the second material 150 has an acoustic impedance that is the same or similar to an acoustic impedance of the first material 140. The second material 150 also may have a fracture toughness that is less than a fracture toughness of the first material 140.

In some embodiments, the second material 150 is an intermetallic material where a primary element of the intermetallic material is the same as a primary element in the first material 140. For example, Ni₃Al or NiAl are suitable intermetallic material for the second material 150 where the first material 140 is a nickel-based superalloy. In another example, TiAl is a suitable intermetallic material for the second material 150 where the first material 140 is a titanium-based alloy. In one non-limiting example, the second material 150 has a ductility, as measured by elongation to fail, at room temperature of less than about 8% and a fracture toughness at room temperature of less than about 10 ksi√in. In one example, the second material 150 has a ductility, as measured by elongation to fail, at room temperature of less than about 5% and a fracture toughness at room temperature of less than about 10 ksi√in. In one example, the second material is nickel aluminide (Ni₃Al).

Further, the second material 150 may have an acoustic impedance that is the same or similar to the acoustic impedance of the first material 140. For example, the second material 150 may have an acoustic impedance that differs from the acoustic impedance of the first material 140 by no more than about 20%, about 10%, about 5%, or about 2%. A second material 150 with an acoustic impedance within the aforementioned ranges may make the second material 150 invisible or nearly invisible ultrasonically within the calibration block 100. Using a second material 150 with an acoustic impedance that is the same or similar to that of the first material 140 ensures that the presence of the second material 150 within the calibration block 100 produces a low signal, for example, during ultrasonic inspection. In this manner, any signal resulting from material differences in the calibration block 100 are minimized or reduced and the crack 110 produces the dominant signal when using the calibration block 100.

In the calibration block 100, there is diffusion between the first material 140 and the second material 150 such that there is a metallurgical bond between the first material 140 and the second material 150. In some aspects, there may be a metallurgical bond between the first material 140 and the second material 150 such that there is substantially no cracking or, in some aspects, no cracking along an interface between the first material 140 and the second material 150. Diffusion between the first material 140 and the second material 150 and the absence of cracks along the interface between the first material 140 and the second material 150 may help to ensure that the presence of the uncracked portion of the second material 150 within the calibration block 100 produces a low signal, for example, during ultrasonic inspection. In this manner, any signal resulting from material differences in the calibration block 100 are minimized or reduced and the crack 110 produces the dominant signal when using the calibration block 100.

In some embodiments, the calibration block 100 has a density greater than about 95% of theoretical density. A high density may approximate the structural alloy of a target or real-world part being inspected. Further, a high porosity would be visible via the NDE inspection technique and may add noise to the calibration. For example, signals picked up by a NDE inspection device due to a high porosity of the calibration block may compete with a signal coming from the crack 110 in the calibration block 100.

Although the calibration block 100 is depicted as a cylinder in FIG. 1, it is contemplated that the calibration block 100 may be formed in any suitable shape or size. By some approaches, the calibration block 100 or portions thereof may be shaped to mimic a target part to be inspection. In some examples, a portion of the calibration block 100 has a geometry that mimics the shape of a portion of a target part to be inspected. For example, a portion of the outer surface 120 has a geometry that mimics the shape of an outer surface of a target part to be inspected. In one example, if the target part may be a airfoil for a compressor blade or stator vane and a portion of the outer surface 120 may have a geometry that corresponds to a shape of the airfoil. In this manner, the calibration block 100 may have an entry surface 160 for ultrasonic waves that mimics an entry surface of the target part to further align the calibration block 100 with real-world inspection conditions. The entry surface 160 refers to a surface of the part where ultrasonic waves enter the part.

By some approaches, the calibration block 100 may be used as a reference standard to calibrate NDE equipment such as ultrasonic testing equipment. In some examples, the calibration block 100 can be used as a reference standard for the size, geometry, and/or location of a crack in a target or real-world part to be inspected. Because the calibration block 100 has a crack 110 of a known size and location, it is possible to estimate the size of a crack in a part by comparing the signal from the crack 110 in the calibration block 100 to that generated from a crack in the real-world part.

Turning to FIG. 2, a method 200 of manufacturing a calibration block, in particular a cracked calibration block, is shown. The cracked calibration block includes a first material (e.g., a hard to crack material when subjected to small strains) and a second material (e.g., an easier to crack material). In particular, the method 200 may be used to manufacture a cracked calibration block with a crack of a predetermined length at a predetermined location. The calibration block manufactured by the method 200 can be used to calibrate inspection equipment, such as NDE equipment, and to provide a known point of comparison for inspection of a target part. By some approaches, the method 200 may be used to form the crack 110 in the calibration block 100 that is shown and described with reference to FIG. 1.

At block 210, the method 200 includes embedding, placing, positioning, or disposing the second material within the first material at a target position. As described further below, the target position ultimately sets the location of the crack to be formed in the calibration block in the method 200. In some examples, the target position may be a distance from an external surface, such as a bottom wall, of the container. For example, the target position may be a target height of the first material within the container, as measured from a bottom wall or a top wall of the container.

The second material may be less ductile (e.g., more brittle) than the first material. Further, the second material may have a fracture toughness that is less than a fracture toughness of the first material. In this manner, once the uncracked solid body is formed, the second material may be easier to crack than the first material. Embedding or placing a material that is easier to crack than the first material may allow a crack to be introduced into the calibration block. Further, the second material may have an acoustic impedance that is the same or similar to an acoustic impedance of the first material. Thus, once the calibration block is formed, the second material may be invisible or nearly invisible via inspection devices, such as ultrasonic inspection devices. That is, an interface between the first material and the second material may generate no or a low signal during ultrasonic inspections. In this manner, the second material allows a crack to be introduced into a calibration block comprised of an otherwise hard to crack material (e.g., the first material) while not interfering with ultrasonic inspection results during the calibration process.

In some embodiments, the first material is the first material 140 described with reference to FIG. 1. By some approaches, the first material 140 is in the form of a powder when filling the container. In some examples, the first material 140 is an atomized powder.

In some embodiments, the second material is the second material 150 described with reference to FIG. 1. By some approaches, the second material is a discrete block, chunk, or piece of solid, consolidated material that is disposed within the first material.

The second material may be a consolidated piece of material that has at least one dimension that defines a target crack size for a crack to be formed in the calibration block. For example, later steps of the method 200 (see block 230) involves deforming the calibration block to create cracks in the second material but not in the first material. Thus, the size and/or dimensions of the piece of the second material may set or dictate the size (e.g., the target size) of the crack formed in the calibration block. A crack may travel through the second material during deformation but stops propagating when it reaches the first material.

By some approaches, embedding or placing the second material within the first material includes filling a container to the target position with a first material (e.g., which is in powder form), placing the second material in the container at the target position, and filling a remainder of the container with the first material. The container may be subjected to the heat and pressure to fuse the first material and the second material and form the uncracked solid body.

Any suitable container can be used to manufacture the calibration block. In one non-limiting example, the container is a hot isostatic pressing (HIP) container. Further, the container may be of any suitable shape and size, for example, based on the desired or target shape of the calibration block. By some approaches, the container is sized to enable formation of a target shape for the calibration block (e.g., the calibration block to be created via the method 200). The target shape of the calibration block may be such that the signal from an inspection device can be captured by the receiver. When the calibration block is used to calibrate ultrasonic testing equipment, the target shape may be dictated, at least in part, by possible sound paths along which ultrasonic waves travel to/from a transducer in relation to the crack in the calibration block. For example, the calibration block may be sized to be large enough such that sound waves reflected from the crack, when considering possible crack positions and/or angles, can be received by the transducer of the ultrasonic testing equipment.

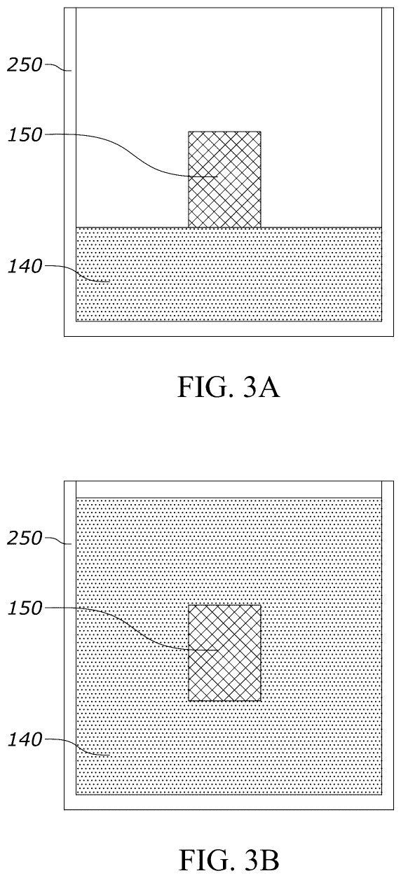

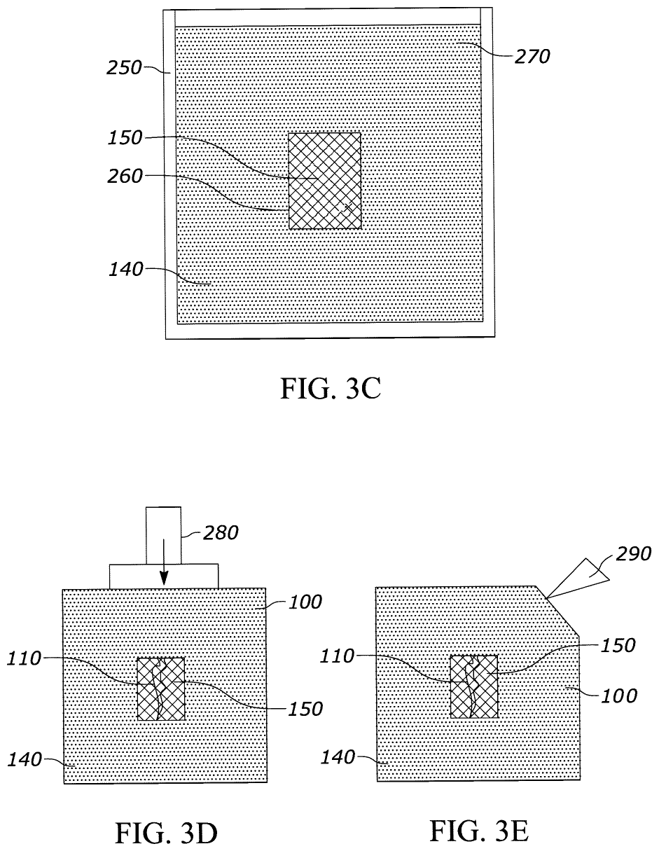

Referring briefly to FIGS. 3A and 3B, example schematic diagrams show the placement of the second material within the first material at a target position as described in block 210 of FIG. 2. In FIG. 3A, the first material 140 (e.g., in powder form) is added to a container 250 (e.g., a HIP container). The first material 140 is added to a level in the container 250 to position the second material 150 at the target position. The second material 150 is then added to the container 250 at the target position. In FIG. 3B, more of the first material 140 is added to the container 250 to fully cover or surround the second material 150.

At block 220, the method 200 includes subjecting the first material and the second material to heat and pressure to create a solid body that forms an uncracked solid body. This forms the uncracked solid body in the target shape. By some approaches, the first material and the second material are subjected to heat (e.g., a temperature) and pressure sufficient to cause diffusion between the first material and the second material. In some examples, a HIP chamber may be used to subject the first material and second material to heat and pressure. Further, the heat and pressure may create a metallurgical bond between the first material and the second material with no or substantially no cracking present along an interface of the first material and the second material. Thus, any signal resulting from the interface or material differences is minimized or reduced, and the crack produces the dominant signal when inspecting the cracked calibration block.

By some approaches, the heat and pressure may also be sufficient to create a solid body formed from the first material and the second material that has a density greater than about 95% of a theoretical density.

By some approaches, a hot isostatic pressing (HIP) is used to subject the first material and the second material to heat and pressure sufficient to create the solid body, the solid body containing the first material and the second material with the first material being joined to the second material with a metallurgical bond. The first material and the second material may be subjected to heat and pressure in an HIP container to form the uncracked solid body.

In some embodiments, the uncracked solid body is machined so one or more portions of the uncracked solid body are conducive to forging for strain input.

Referring briefly to FIG. 3C, an example schematic diagram shows an interface between the first material and the second material in the uncracked solid body as described in block 220 of FIG. 2. FIG. 3C illustrates an interface 260 between the first material 140 and the second material 150 in the uncracked solid body 270.

At block 230, the method 200 includes deforming the uncracked solid body to create at least one crack in the second material and form a cracked calibration block. Any suitable equipment or device may be used to deform the calibration block. For example, deformation may be achieved using a forging press. In some embodiments, deforming the uncracked solid body creates the at least one crack in only the second material and does not cause cracking in the first material and/or at the interface of the first material and the second material. By some approaches, deforming the uncracked solid body includes subjecting the uncracked solid body to a strain and a temperature sufficient to crack the second material without cracking the first material. Deforming the uncracked solid body may create a controlled crack fully contained in the second material to form a cracked calibration block.

It is to be understood that the uncracked solid body need not be physically deformed at block 230 to form the cracked calibration block. For example, any suitable force such as pressures, strains, etc. may be applied to the uncracked calibration block to form the at least one crack at block 230. The forces, however, may not result in a change in shape or physical distortion of the uncracked solid body.

By some approaches, the uncracked solid body may be subjected to an amount of strain sufficient to crack the second material without changing the microstructure of the first material. In some examples, the uncracked solid body is subjected to a strain at room temperature of in the range of about 2% to about 20%, about 2% to about 15%, or about 2% to about 12% or, in some aspects, a strain at room temperature of about 10%. In another example, the uncracked solid body is subjected to a strain at room temperature of up to about 20%. Strain (e.g., change in length divided by initial length) is a unitless quantity. For the aforementioned strains, the unitless quantity was multiplied by 100 to represent the strain as a percent. In yet other examples, the uncracked solid body is subjected to the minimum strain needed to crack the second material while preserving the microstructure of the first material.

In some embodiments, an interface of the first material and the second material in the cracked calibration block produces a signal amplitude that is less than about 50% a signal amplitude produced by the crack (e.g., the controlled crack) within the second material as detected by an inspection device. An interface of the first material and the second material that is within in the aforementioned range may be achieved, for example, by using a second material that has an acoustic impedance that is sufficiently close to an acoustic impedance of the first material. Further, diffusion between the first material and the second material, for example, such that there are no cracks or substantially no cracks at the interface of the first material and the second material may contribute to the signal amplitude of the interface being less than about 50% a signal amplitude produced by the crack. Having an interface of the first material and the second material that is less than about 50% a signal amplitude produced by the crack helps to ensure that the crack in the calibration block produces the dominant signal as detected by an inspection device. In ideal circumstances, the signal from interface would be the same as the signal from the first material such that the interface looks the same as the first material in an inspection by an inspection device. However, because the material differences (e.g., in density and velocity) due to the second material being incorporated in the first material, the interface likely does not have the same signal as the signal of the first material. Thus, it may be desirable to have a signal from the interface be small relative the signal from the crack such that the signal from the interface does not interfere with the signal from the crack when the calibration block is inspected via an inspection device. Further, ensuring that the second material is well and/or truly bonded to the first material for example, such that there is diffusion between the first material and the second material and substantially free from cracks at the interrace, may help to reduce the signal from the crack and ensure that it falls within the aforementioned range.

Further, in some embodiments, a signal amplitude from the first material in the uncracked solid body is the same as a signal amplitude from the first material in the cracked calibration block as detected by an inspection device. Additionally, the microstructure of the first material is unchanged by deformation of the uncracked solid body. That is, the microstructure of the first material is generally unchanged between the uncracked solid body and the cracked calibration block.

Further, in some embodiments, there is metallurgical bond between the first material 140 and the second material 150 such that there is substantially no cracking or, in some aspects, no cracking along an interface between the first material 140 and the second material 150 after deformation.

Referring briefly to FIG. 3D, an example schematic diagram shows deformation of the uncracked solid body to create at least one crack in the second material and form a cracked calibration block as described in block 230 of FIG. 2. In FIG. 3D, a deforming tool 280 (e.g., a forging press) is used to apply pressure to the uncracked solid body 270 to create the crack 110 and form the calibration block 100.

At block 240, the method 200 includes machining the cracked calibration block to a target shape. The target shape has a geometry that mimics a shape of a target part. The calibration block may be used to calibrate inspection equipment and to provide a known point of comparison for inspection of the target part. By some approaches, the cracked calibration block can be machined to mimic an inspection surface of the target part. For example, the inspection surface may be an entry surface for ultrasonic waves during ultrasonic inspection of the calibration block. In this manner, the inspection surface of the cracked calibration block may be designed to mimic an inspection surface of the target part so that the calibration block simulates the target part more closely for calibration purposes. For example, the inspection surface may be flat and perpendicular to the crack, or the inspection surface may be curved allowing multiple angles with respect to the crack to be evaluated.

Referring briefly to FIG. 3E, an example schematic diagram shows the machining of the calibration block to a target shape as described in block 240 of FIG. 2. In FIG. 3E, a machine 290 is used to machine a surface of the calibration block 100 to the target shape.

The method 200 as described above, results in cracked calibration block that has a crack embedded in an inner volume of the block and, accordingly, is a subsurface crack. By some approaches, the method 200 may further include machining the cracked calibration block to expose the crack at the surface of the calibration block. As such, the resulting method 200 may also be employed to create a cracked calibration block that has a surface crack. A surface crack may enable the calibration block to be used to calibrate eddy current inspection, fluorescent penetrant inspection, or the other surface inspection equipment.

Further, in some embodiments, the method 200 optionally includes performing a first inspection of the uncracked solid body before it is deformed. The first inspection may validate that there are no cracks present in the uncracked solid body before it is deformed to introduce a controlled crack and/or that there was joining of the first material and the second material. In some embodiments, the method 200 also includes performing a second inspection of the cracked calibration block after deforming the uncracked solid body. The second inspection may validate, for example, that the second material is cracked. The second inspection may also be used to generate a signal on an inspection device, such as a UT inspection device, that can provide a known point of comparison for signals generated from inspection of a target part. In some examples, the first and second inspections are volumetric inspections. The first and second inspections may include one or more of an ultrasonic inspection, a computed tomography (CT) inspection, an eddy current inspection, or an infrared detection inspection.

In yet other embodiments, one or more steps of the method 200 may be performed via an additive manufacturing or build process. For example, the uncracked solid body may be formed via an additive manufacturing process. In one example, the second material is additively printed within the first material during the additive build process. The additive structure is then subject to heat and pressure to achieve a solid body that is greater than about 95% of theoretical density. The additive build process may include powder fed or wire fed directed energy deposition.

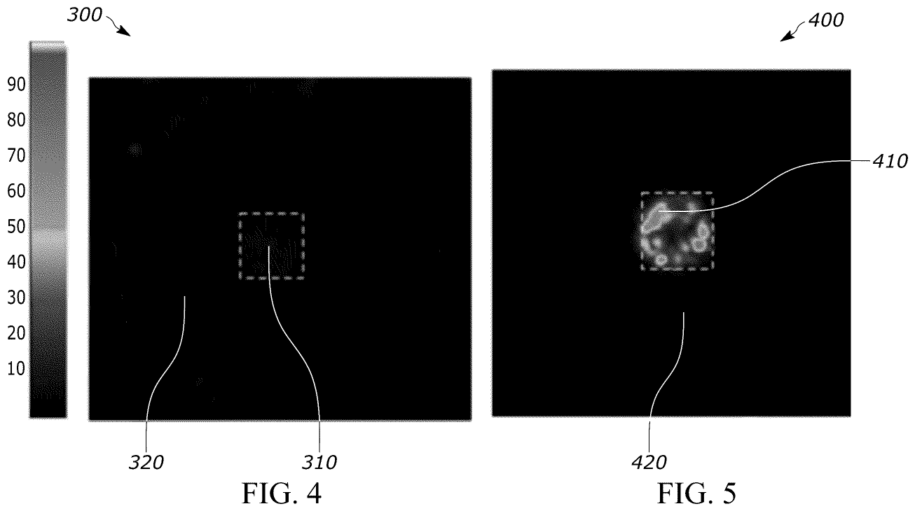

FIGS. 4 and 5 are ultrasound C-scan images of a calibration block formed via the method described herein.

FIG. 4 is an image of an uncracked solid body 300. The uncracked solid body 300 has a generally circular cross section in the plane of the image. The uncracked solid body 300 was formed via the method 200 described with reference to FIG. 2, after the first and second material are joined via heat and pressure by HIP but before deformation (e.g., cracking). The image of FIG. 4 was acquired from a top plan view of the calibration block (e.g., with reference to the orientation of the calibration block 100 shown in FIG. 1). The first location 310 is an area of the uncracked solid body 300 that includes the second material disposed within the first material. The second location 320 is an area of the uncracked solid body 300 that includes the first material only.

FIG. 5 is an image of a cracked calibration block 400. The cracked calibration block 400 was formed via the method 200 described with reference to FIG. 2, after deformation (e.g., cracking). The image of FIG. 5 was acquired from a top plan view of the calibration block (e.g., with reference to the orientation of the calibration block 100 shown in FIG. 1). The first location 410 is an area of the cracked calibration block 400 that includes the second material disposed within the first material. The second location 420 is an area of the cracked calibration block 400 that includes the first material only. At the second location 420, the first material is uncracked.

In FIG. 5, the contrast in the first location 410 corresponds with cracks in the cracked calibration block 400. The contrast forms an image representing the acoustic impedance mismatch at each location in the cracked calibration block 400. The level of contrast (e.g., light to dark) represents the amplitude of the ultrasound reflection. The scale at the left of FIGS. 4 and 5 shows the correspondence between the level of contrast shown in the figures and the amplitude of the ultrasound reflection represented by the level of contrast. Because areas of acoustic impedance mismatch (e.g., the interface between the first material and the second material) create ultrasonic reflections that are larger than that of the first material and that cracks also result in areas of acoustic impedance mismatch, the level of contrast corresponding to high amplitudes show regions of material with large acoustic impedance mismatch which implies material defects.

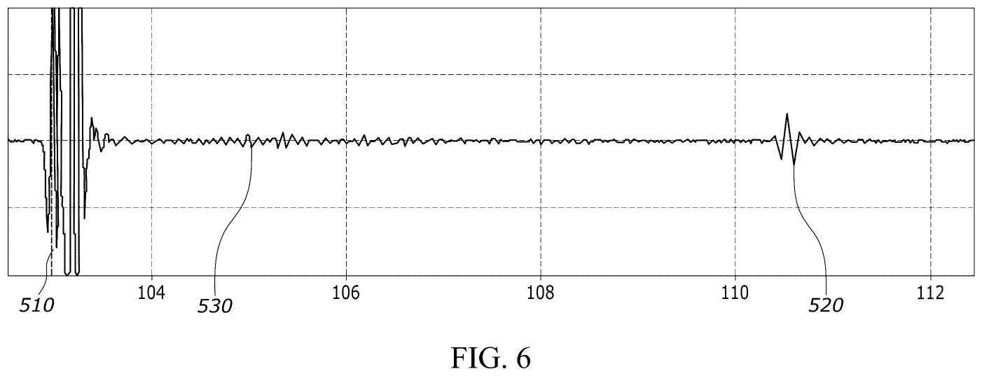

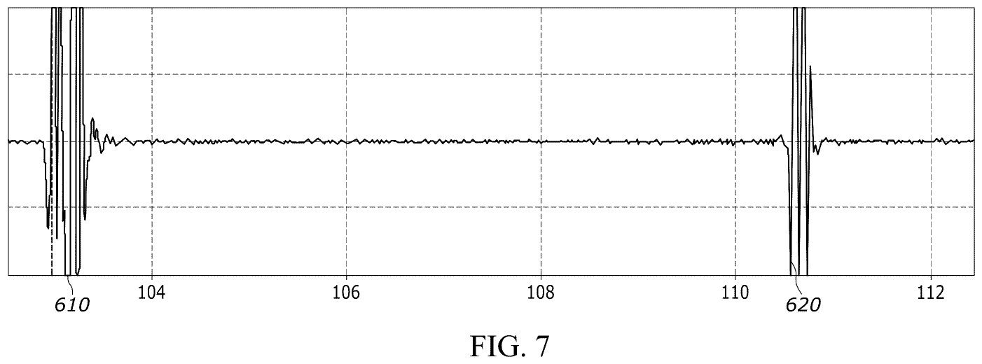

FIGS. 6 and 7 include ultrasonic (UT) inspection data acquired by inspecting the uncracked solid body 300 of FIG. 4. The UT inspections of the uncracked solid body 300 were used to validate that there was diffusion between the first material and the second material such that there was no significant signal from an interface between the materials present in the UT inspection data.

FIG. 6 shows UT inspection data from the first location 310 of the uncracked solid body 300, which includes the second material imbedded in the first material, as shown in FIG. 4. As shown, after joining the first and second materials together, there is no appreciable signal generated from the interface of the first and second materials in the uncracked solid body 300. Rather, the dominant signals in the UT inspection data are a signal for the top wall of the calibration block 510 and a signal for the bottom wall of the calibration block 520. The second material in the uncracked solid body 300 reduces the amplitude of the signal for the bottom wall of the calibration block 520.

FIG. 6 illustrates that very little echo occurs in the UT signal in the uncracked solid body 300 for UT readings taken over the joined second material, which may also be referred to as the seed. Because the acoustic impedance of the first material is not an exact match of the acoustic impedance of the second material in the uncracked solid body 300, there is some echo or signal generated, as indicated by the signal 530. However, the signal 530 is not significant in that a crack introduced in the uncracked solid body 300 would generate a dominant signal in the UT inspection data.

FIG. 7 shows UT inspection data from the second location 320 of the uncracked solid body 300, which includes only the first material, as shown in FIG. 4. The dominant UT signals in the UT inspection data include a signal for the top wall of the calibration block 610 and a signal for the bottom wall of the calibration block 620. Thus, no cracks were present at the second location 320 before the uncracked solid body 300 was subjected to deformation.

None of the echo or signal from the second material that is observed in FIG. 6 is present in FIG. 7. Additionally, the signal for the bottom wall of the calibration block 620 has a larger amplitude than the signal for the bottom wall of the calibration block 520 in FIG. 6 because the second material (e.g., no seed) is present in the travel path to scatter sound away.

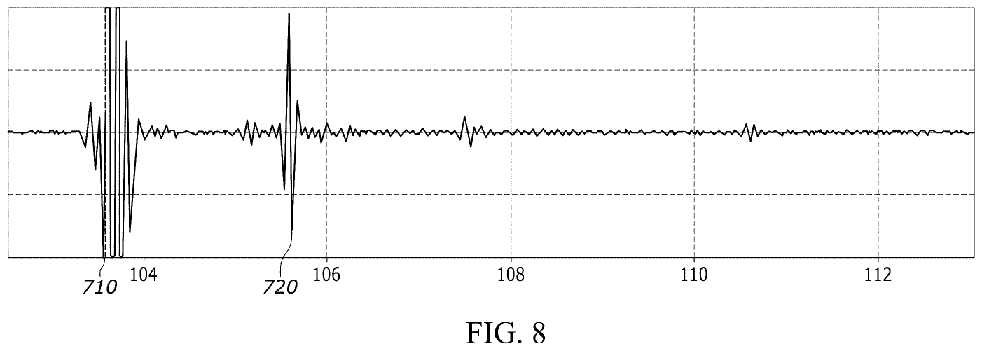

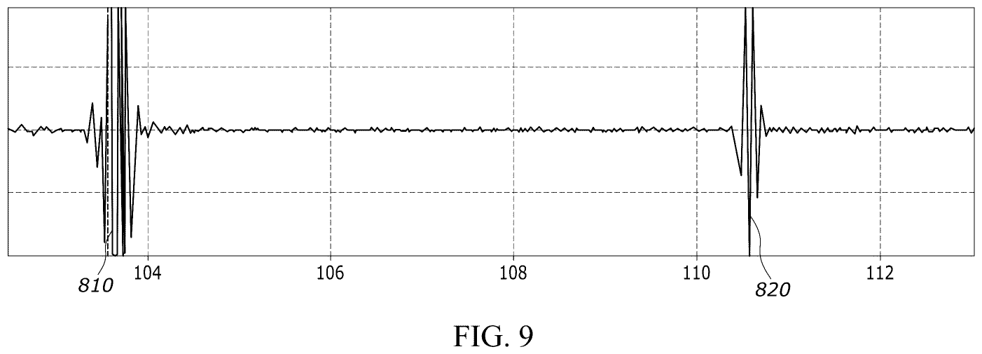

FIGS. 8 and 9 include exemplary ultrasonic (UT) inspection data acquired by inspecting the cracked calibration block 400 of FIG. 5. The UT inspections of the cracked calibration block 400 were used to validate that a crack formed in the second material via the deformation process. Further, the UT inspections of the cracked calibration block 400 were used to validate that a crack was formed in only the second material of the calibration block and not in the first material.

FIG. 8 shows UT inspection data from the first location 410 of the cracked calibration block 400 of FIG. 5. The dominant UT signals in the UT inspection data include a signal for the top wall of the calibration block 710 and a signal for a crack 720 in the second material. The signal for the crack 720 can be used to provide a known point of comparison for inspection of a target part. That is, the crack has a known size that is set by a dimension of the second material in the calibration block and this can be related to the ultrasound signal obtained. For example, an entire dimension (e.g., width) of the second material may crack, thus, defining the crack length for calibration purposes. Such a dimension of the second material may define a maximum crack length, as the crack may be limited to (e.g., may not propagate beyond) the second material. In some examples, the crack may be shorter or smaller than the dimension of the second material. Thus, the signal for the crack 720 can be used as a point of reference to indicate that similar signals generated by the UT inspection device are for cracks of the same size in the target part.

FIG. 9. shows UT inspection data from the second location 420 of the cracked calibration block 400 of FIG. 5. The dominant UT signals in the UT inspection data include a signal for the top wall of the calibration block 810 and a signal for the bottom wall of the calibration block 820. There are no major UT signals present between the top wall and the bottom wall of the cracked calibration block at the second location 420. This indicates that no cracking occurred between the top and bottom walls when the uncracked solid body 300 was deformed to introduce the crack into the second material. Thus, no cracks were formed at the second location 420 when the uncracked solid body 300 was subjected to deformation.

The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated. The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Further aspects of the disclosure are provided by the subject matter of the following clauses:

A calibration block to be used for non-destructive evaluation (NDE) inspection of a part, the calibration block comprising a first material and a second material, the second material positioned within a volume of the first material, the second material having a ductility less than a ductility of the first material, a controlled crack disposed fully within the second material, and an interface between the first material and the second material producing a signal amplitude that is less than about 50% of a signal amplitude produced by the controlled crack within the second material as detected by an inspection device.

The calibration block of any preceding clause, wherein the calibration block has not undergone strains as measured at room temperature in excess of about 20%.

The calibration block of any preceding clause, wherein the interface is formed by diffusion of the first material and the second material.

The calibration block of any preceding clause, wherein the first material is a hard to crack material as defined by a high ductility and a high fracture toughness.

The calibration block of any preceding clause, wherein the calibration block is in a shape of a target part on a gas turbine engine.

The calibration block of any preceding clause, wherein the second material has an acoustic impedance that that differs from an acoustic impedance of the first material by no more than about 20%.

The calibration block of any preceding clause, wherein the second material has a fracture toughness less than a fracture toughness of the first material.

The calibration block of any preceding clause, wherein the first material has a ductility, as measured by elongation to fail, at room temperature of greater than about 8% and a fracture toughness at room temperature of greater than about 25 ksi√in, and wherein the second material has a ductility, as measured by elongation to fail, at room temperature of less than about 5% and a fracture toughness at room temperature of less than about 10 ksi√in.

A calibration block to be used for non-destructive evaluation (NDE) inspection of a part, the calibration block having an outer surface defining an inner volume, the calibration block comprising: a first material filling at least a portion of the inner volume; and a second material disposed in the first material and spaced from the outer surface, the second material including at least one crack disposed fully within a volume of the second material and having a predetermined location and a predetermined maximum length, an interface of the first material and the second material producing a signal amplitude that is less than about 50% a signal amplitude produced by the at least one crack in the second material as detected by an inspection device.

The calibration block of any preceding clause, wherein the second material has a ductility less than a ductility of the first material and has a fracture toughness less than a fracture toughness of the first material.

The calibration block of any preceding clause, wherein the first material has a ductility, as measured by elongation to fail, at room temperature of greater than about 8% and a fracture toughness at room temperature of greater than about 25 ksi√in, and wherein the second material has a ductility, as measured by elongation to fail, at room temperature of less than about 5% and a fracture toughness at room temperature of less than about 10 ksi√in.

The calibration block of any preceding clause, wherein the first material is a structural alloy.

The calibration block of any preceding clause, wherein the structural alloy is at least one of an aluminum-based alloy, a titanium-based alloy, a refractory-based alloy, a nickel-based superalloy, or a steel.

The calibration block of any preceding clause, wherein the second material has an acoustic impedance that differs from an acoustic impedance of the first material by no more than about 20%.

The calibration block of any preceding clause, wherein the second material is an intermetallic material where a primary element of the intermetallic material is the same as a primary element in the first material.

A method of manufacturing a cracked calibration block formed from a first material and a second material, the method comprising: placing the second material within the first material at a target position, the second material having a ductility less than a ductility of the first material and having an acoustic impedance that that differs from the acoustic impedance of the first material by no more than about 20%; subjecting the first material and second material to heat and pressure to create an uncracked solid body having a density greater than 95% of theoretical density, the heat and pressure sufficient to cause diffusion between the first material and the second material creating a metallurgical bond; and deforming the uncracked solid body to create a controlled crack fully contained in the second material to form a cracked calibration block.

The method of any preceding clause, wherein deforming the uncracked solid body includes subjecting the uncracked solid body to a strain sufficient to crack the second material without cracking the first material forming the cracked calibration block.

The method of any preceding clause, wherein deforming the uncracked solid body includes subjecting the uncracked solid body to a strain at room temperature of up to about 20%.

The method of any preceding clause, wherein placing the second material in the first material includes: filling a container to the target position with a powder of the first material; placing a consolidated piece of the second material in the container at the target position; and filling a remainder of the container with the powder of the first material, wherein the container is subjected to the heat and pressure to form the uncracked solid body.

The method of any preceding clause, further comprising: machining the cracked calibration block to a target shape, the target shape having a geometry that mimics a shape of at least a portion of a target part to be inspected.

The method of any preceding clause, further comprising: machining the cracked calibration block to expose the controlled crack to a surface of the cracked calibration block to form a surface crack.

The method of any preceding clause, wherein the uncracked solid body is formed via an additive manufacturing process.

The method of any preceding clause, wherein an interface of the first material and the second material produces a signal amplitude that is less than about 50% a signal amplitude produced by the controlled crack within the second material as detected by an inspection device.

What is claimed is:

1. A calibration block to be used for non-destructive evaluation (NDE) inspection of a part, the calibration block comprising a first material and a second material, the second material positioned within a volume of the first material, the first material being a hard to crack material that has a ductility less than a ductility of the first material, a controlled crack disposed fully within the second material, and an interface between the first material and the second material producing a signal amplitude that is less than about 50% of a signal amplitude produced by the controlled crack within the second material as detected by an inspection device.

2. The calibration block of claim 1, wherein the interface is formed by diffusion of the first material and the second material.

3. The calibration block of claim 1, wherein the second material has an acoustic impedance that that differs from an acoustic impedance of the first material by no more than about 20%.

4. The calibration block of claim 1, wherein the second material has a fracture toughness less than a fracture toughness of the first material.

5. The calibration block of claim 4, wherein the first material has a ductility, as measured by elongation to fail, at room temperature of greater than about 8% and a fracture toughness at room temperature of greater than about 25 ksi√in, and wherein the second material has a ductility, as measured by elongation to fail, at room temperature of less than about 5% and a fracture toughness at room temperature of less than about 10 ksi√in.

6. A calibration block to be used for non-destructive evaluation (NDE) inspection of a part, the calibration block, the calibration block having an outer surface defining an inner volume, the calibration block comprising:
a first material filling at least a portion of the inner volume; and
a second material disposed in the first material and spaced from the outer surface, the second material including at least one crack disposed fully within a volume of the second material and having a predetermined location and a predetermined maximum length, an interface of the first material and the second material producing a signal amplitude that is less than about 50% a signal amplitude produced by the at least one crack in the second material as detected by an inspection device.

7. The calibration block of claim 6, wherein the second material has a ductility less than a ductility of the first material and has a fracture toughness less than a fracture toughness of the first material.

8. The calibration block of claim 7, wherein the first material has a ductility, as measured by elongation to fail, at room temperature of greater than about 8% and a fracture toughness at room temperature of greater than about 25 ksi√in, and wherein the second material has a ductility, as measured by elongation to fail, at room temperature of less than about 5% and a fracture toughness at room temperature of less than about 10 ksi√in.

9. The calibration block of claim 6, wherein the first material is a structural alloy.

10. The calibration block of claim 9, wherein the structural alloy is at least one of an aluminum-based alloy, a titanium-based alloy, a refractory-based alloy, a nickel-based superalloy, or a steel.

11. The calibration block of claim 6, wherein the second material has an acoustic impedance that differs from an acoustic impedance of the first material by no more than about 20%.

12. The calibration block of claim 6, wherein the second material is an intermetallic material where a primary element of the intermetallic material is the same as a primary element in the first material.

13. A method of manufacturing a cracked calibration block formed from a first material and a second material, the method comprising:
placing the second material within the first material at a target position, the second material having a ductility less than a ductility of the first material and having an acoustic impedance that that differs from the acoustic impedance of the first material by no more than about 20%;
subjecting the first material and second material to heat and pressure to create an uncracked solid body having a density greater than 95% of theoretical density, the heat and pressure sufficient to cause diffusion between the first material and the second material creating a metallurgical bond; and
deforming the uncracked solid body to create a controlled crack fully contained in the second material to form a cracked calibration block.

14. The method of claim 13, wherein deforming the uncracked solid body includes subjecting the uncracked solid body to a strain sufficient to crack the second material without cracking the first material forming the cracked calibration block.

15. The method of claim 13, wherein deforming the uncracked solid body includes subjecting the uncracked solid body to a strain at room temperature of up to about 20%.

16. The method of claim 13, wherein placing the second material in the first material includes:
filling a container to the target position with a powder of the first material;
placing a consolidated piece of the second material in the container at the target position; and
filling a remainder of the container with the powder of the first material, wherein the container is subjected to the heat and pressure to form the uncracked solid body.

17. The method of claim 13, further comprising:
machining the cracked calibration block to a target shape, the target shape having a geometry that mimics a shape of at least a portion of a target part to be inspected.

18. The method of claim 13, further comprising:
machining the cracked calibration block to expose the controlled crack to a surface of the cracked calibration block to form a surface crack.

19. The method of claim 13, wherein the uncracked solid body is formed via an additive manufacturing process.

20. The method of claim 13, wherein an interface of the first material and the second material produces a signal amplitude that is less than about 50% a signal amplitude produced by the controlled crack within the second material as detected by an inspection device.
